(19) United States
(12) Patent Application Publication
(10) Pub. No.: US 2007/0223710 A1
(43) Pub. Date: Sep. 27, 2007

(54) Hearing aid to solve the 'Cocktail Party' problem

(76) Inventors: Peter Laurie, Abbotsbury (GB); Tom Fortescue, Wotton Fitzpaine (GB)

Correspondence Address: PETER LAURIE, 1 MARKET ST., ABBOTSBURY, DORSET, DT3 4JR, GB

(21) Appl. No.: 11/371,368

(22) Filed: Mar. 9, 2006

(51) Int. Cl. H04R 29/00

(52) U.S. Cl. 381/56

(57) ABSTRACT

A real-time method of measuring the true directions of sounds in rooms, halls, etc in order that sound amplifying or recording equipment may distinguish between different sound sources, reproducing one or more and attenuating the others at the user's choice so as to reduce the unintelligibility which is often caused by multiple sound sources in an environment which is echoing and or resonant.

### PRIOR APPLICATION

U.S. Provisional Patent Application 60/655,032 Filed Mar. 16, 2005

U.S. Non-provisional Patent Application 11/371,368 Filed Apr. 7, 2006.

### GENERAL FIELD OF THE INVENTION

The invention lies within the problem area known as ‘source separation’ in acoustics and signal processing.

### BACKGROUND

It is well known that current sound detection and amplification systems do not work well when exposed to sounds from many sources particularly in rooms or halls. The listener to the combined signal often hears a jumble of noise and may be unable to separate individual speakers from other speakers and background sounds. This problem causes difficulties in many related fields such as broadcasting the voices of speakers in meetings, the ability of hearing aids to resolve the voices of individuals in groups, conference call facilities in telephony, resolution of acoustic echoes in sonar, radio signals reflected among buildings and the like. Wherever wave energy is released into an environment which can generate echoes this invention makes it possible to measure the direction of the sound source without being confused by echoes and resonances.

In acoustics this is often called the ‘Cocktail Party’ problem and we claim to solve it by our invention. We are concentrating our efforts on the design of a hearing aid that will overcome it, and the description that follows will be given in terms of acoustic energy in rooms but the invention will provide a solution to the same fundamental problem in relation to other forms of wave energy in other environments.

Hearing aids do not work well when the wearer is in group of people. The effect is worse indoors. The user can hear a jumble of noise which he or she cannot resolve into individual voices and cannot understand.

The reason for the jumble of noise is that each sound made by a person in the room arrives at the hearer together with its echoes from floor, walls, ceilings, tables and other furniture plus second echoes of the first, plus third echoes of the second echoes, and so on, plus resonances that the sound may excite in the room. A person with normal hearing can usually resolve this confusion of sound and is often able to separate out the speech sources so that he or she can follow one conversation and ignore the rest.

As a person's hearing deteriorates this ability is reduced. Furthermore, the sound amplified and relayed to the ear by a normal hearing aid lacks directional information and makes separation into voices almost impossible.

A similar effect is found when a sound recording or broadcast is made from a microphone in a crowded room. If any intelligible speech is to be heard the microphone must be very close to the speaker in order to give his or her voice prominence over the background babble.

Although the problem is called after a cocktail party it is not necessary to gather a crowd to produce the effect. Many people who wear hearing aids cannot understand general conversation among half a dozen people round a table. Since this is the setting of much social interaction in our culture their deprivation is severe.

### SUMMARY OF THE INVENTION

This description of our invention is explained in terms of a hearing aid but could equally well be realised in many essentially similar devices using wave energy of different sorts.

The hearing aid described here uses 4 microphone channels but is not limited to that number and could have 3 or more.

It is realised by using commercially available microphones, amplifiers, digital signal processing chips and related equipment. This technology is well known and allows sound from several microphones to be digitised at up to 96,000 samples a second or more in each channel. We are then able to process the digitised signals in readily available Digital Signal Processors using computer programs to embody the innovative parts of our invention. We then feed the processed sound to the wearer via standard ear pieces.

Human speech consists of short bursts of sound at a number of frequencies. It is usually considered that most useful speech information is conveyed by sounds with frequencies between 80 and 4,000 cycles per second. There is a complex science of phonetics and speech analysis which studies these sounds and their relationships with each other, with which we are not concerned. Our starting point is that each speaker in the room lies in a particular direction from the hearer. It is unusual for two speakers to be in the same direction—that is, one behind each other.

Our method for resolving the confusion of sounds is to measure the direction from which each sound arrives at the hearing aid. If this is done accurately for all frequencies of interest it will identify the various speakers in the room by their directions from the listener.

Since our processing algorithm attaches a direction to each sound frequency and these directions cluster about the true directions of the speakers, it is possible in principle to make choices between speakers. The wearer of the equipment will be able to favour one speaker so that the sounds he or she makes are heard in the ear pieces and to discard the sounds made by all the others. In this way the ‘cocktail party’ problem is overcome. The listener is presented with one comprehensible voice out of many.

The invention allows either for:
1. The dynamic selection of a preferred direction of hearing by the user. The necessary human interaction with the equipment may be in one of many well known ways: by turning a knob, rolling a tracker ball, moving a mouse, by equipment that tracks the directions in which the eyeballs are moved and so on.
2. Alternatively the equipment may be preset to prefer one direction and the user turns the equipment to enable him or her to listen to sounds in that direction. The microphones and processing equipment may be mounted on the body or the head, which is naturally turned towards the speaker.
3. The equipment embodying the invention may be built into other equipment which employs it as if it were a human. For instance one can imagine an automated buggy carrying sound transmission equipment which roams a conference hall recording at each moment the voice of one out of many speakers.

It may be desirable to inject all the other conversations and sounds in the room at a low volume into the output so that the user is conscious of other events in the room.

### SUMMARY OF THE INVENTION

Again, this description is given in terms of sounds and acoustic energy, but the same principles apply to the radiation of any wave energy.

Given two microphones close to each other in free field, far from any reflecting surfaces, we could measure the direction of a sound relative to the line joining the microphones by measuring the time of its arrival in each microphone. The time difference is proportional to the cosine of the angle from which the sound arrives.

In practice we do not get individual pulses of sound from human speakers. We get reasonably steady tones without sharply defined beginnings and in this case we compare the phases of the sound at each frequency in the microphones and this will apply in general to any wave energy.

Unfortunately humans do not conduct their conversations in a ‘free field’ (by which we mean an anechoic environment). In our culture many conversations take place in rooms with relatively flat walls, floors, ceilings, tables and other furniture. Each of these surfaces reflects the many sound frequencies emitted by the speakers. Furthermore, when the distance between two reflecting surfaces is an exact multiple of the wavelength of a sound a resonance will be excited which will also appear in the microphones.

So, at any particular frequency, sounds arrive at the microphones from a number of directions. All the different sounds at the same frequency combine in each microphone to make a single wave with a measurable but unpredictable amplitude, phase and frequency.

This makes the calculation of the direction of the speaker, as outlined above, impossible. Attempts to carry it out can produce a different direction for each sound sample.

However cultural factors set some limits to the effects of echoes and resonances. We note that:
1. People tend to be between 3 and 10 feet (roughly) apart when they speak to each other.
2. Reflecting surfaces are rarely closer than a couple of feet to the line joining a speaker and listener. A commonly seen situation is two persons sitting down, talking to each other across a table. The table surface will usually be a foot or a foot and half from the line joining their mouths and ears. Or, they might be standing on a floor, in which case the nearest reflecting surface will be 5 feet or so away. The ceiling will often be as far above them or more.
3. In many rooms, offices, shops etc there are resonant paths short enough to support resonances throughout the frequency range of speech.
   The Invention

Our invention relies on a simple insight, which does not seem to have been noticed or exploited before. Speech sounds consist of short bursts at a number of frequencies, which may vary slowly during the duration of a burst. Bursts last, very roughly, a tenth to a fifth of a second. Ordinary digital signal processing technology allows us to record these sounds accurately. Well known programming algorithms such as the Fourier Transform, power estimation by the method of Least Squares and the like allow us to separate out each frequency from the complete voice signal and to follow its changes in amplitude and phase.

Providing there is a clear path between emitter and receiver—in this example speaker and listener—our insight is that when a new sound-burst, whether as part of speech or some other form of wave energy, arrives at the receiver—the hearer—it arrives in a number of stages:
1. The pure sound arrives first, before any echoes and resonance. This is because the direct path length between speaker and listener must be shorter than by way of any reflecting surface. See FIG. 1. We would justify this statement from the ancient and well known theorem of plane geometry, that any one side of a triangle is always shorter than the other two. As an example, consider a conversation taking place between people sitting at a table. The people are, say, 3 feet apart and their heads are 1′6″ above the table surface. Since sound travels at roughly 1000′ a second, the direct sound takes 3 thousandths of a second (3 ms) to travel from the speaker to the listener. Sound is also reflected from the table between them. Pythagoras' theorem allows us to calculate that the reflected wave travels roughly 4′3 so this takes 4.25 ms. We therefore hear the direct, pure sound at the microphone for 1.25 ms before the first echo arrives. During this period, given more than one microphone, we can measure the sound's direction, as if speaker and listener were in a free field. We can attach this direction to each new frequency emitted by the speaker. See FIG. 3.
2. After this period of pure sound the echoes start to arrive and merge with the direct sound to alter its measured amplitude and phase. This effect, as explained above, makes phase comparisons between microphone signals useless for the measurement of direction. See FIG. 4.
3. Finally, when the sound has had time to travel all over the room and to find out the resonant paths, we start to hear resonances by which we mean echoes that repeatedly travel the same paths, reinforcing themselves in the process. Typical rooms may have floor to ceiling distances of 8′ or corner to corner diagonals of 15′ or so. A resonance has to travel this distance at least twice before it can get established, so we detect their arrival in the microphones after about 15 to 30 ms. This effect makes direction finding even more difficult. By the time the echoes and resonances are fully established the apparent amplitude of the sound may well have increased by a factor of as much as three or more. The several stages of the arrival of a sound wave are illustrated in FIG. 2.

Our method is to analyse the sounds accurately and methodically over very short time periods—typically only a few cycles at each frequency. We use well known methods in acoustic processing embodied in a program running in a conventional digital computer or digital signal processing (DSP) chip or a similar device. Given a start by stage 1 above, we can measure the initial phase and amplitude and calculate the initial direction by comparing the signals in a pair of microphones. If the device is equipped with three or more microphones, there is more than one pair from which a sound direction can be calculated. In general the directions at each frequency indicated by one pair, will be different from those indicated by other pairs. The ‘pure moment’ at a particular frequency is signalled by a minimum value of the spread of directions among the microphone pairs, and we claim that the mean direction at this time can be taken to be the direction of the original sound source.

We claim to be able to detect and remove the resonance component by observing that, when a closed volume such as an organ pipe or a room resonates at a particular frequency, the phase of the oscillation is everywhere the same inside it, though the magnitude will exhibit a spatial oscillation. It is possible to write equations to describe the resonant component of the sound at each microphone. Given enough microphones it is possible to solve them and subtract the reconstructed waves from the corresponding signal. This improves audibility and the accuracy of the ‘pure moment’ detection process described above.

Since the phase and amplitude of tone bursts in human speech and in many other practical applications vary slowly—that is in relation to the rate of sampling and frequency measurement we can employ in a practical device—we can track tone bursts during their life times. If we select a frequency for transmission to the user on the basis of its direction, we can track the relatively slowly changing frequency and amplitude of the tone and output a tone to the hearer that mimics these changes.

As a result the selected tone will be heard and tones—including echoes and resonances—from directions that are not wanted, can be suppressed or played at a lower amplitude.

### DESCRIPTION OF EACH FIGURE OF THE DRAWINGS

FIG. 1: Illustrating the fact that the echo path is always longer than the direct path.

FIG. 2: Recording of the arrival of a 4 kHz tone burst at a single microphone in a typical small room. The pure tone arrives in Phase 1, lasting about 1 ms. Three echoes arrive in Phase 2. In Phase 3, after about 11 ms we see the quick exponential onset and substantial amplitude of room resonance.

FIG. 3: Signals from 4 microphones at the start of the pulse above. The sound source is dead ahead and the 4 traces are very similar in phase and amplitude.

FIG. 4: The first echo appears at the end of Phase 1 in FIG. 2. The 4 microphone traces begin to differ in amplitude and phase.

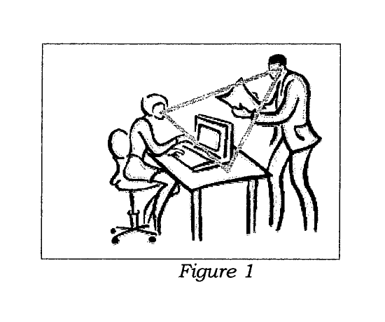

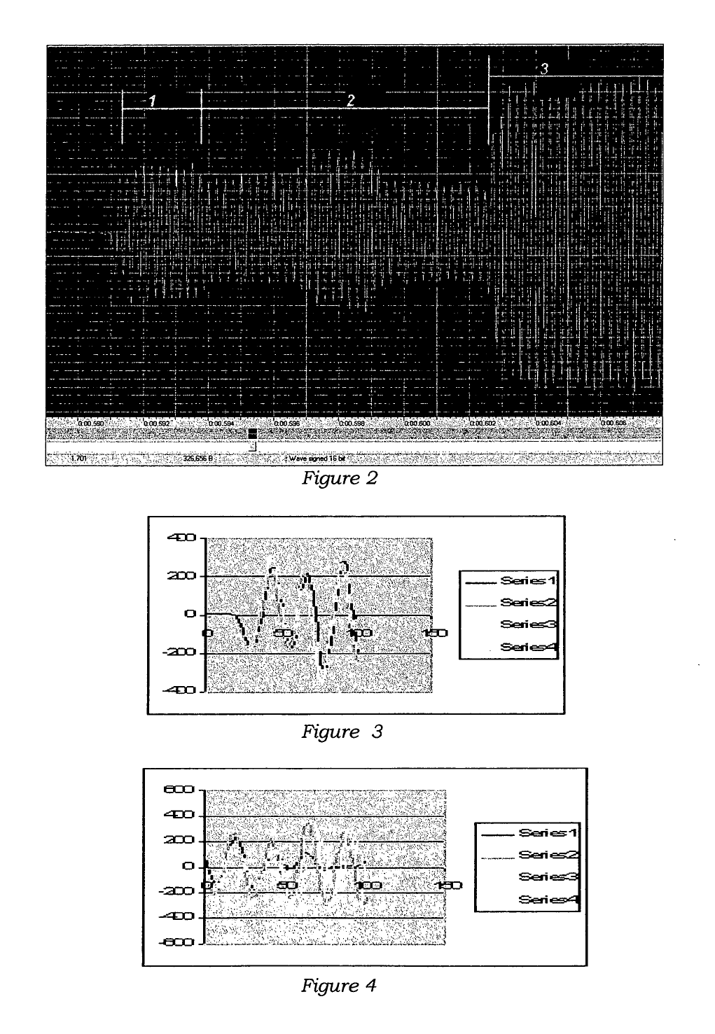

### DESCRIPTION OF THE PREFERRED EMBODIMENT

The device will consist of a number of detectors of the wave energy to be detected and measured. In all cases the volume of operation of the detectors will be substantially smaller then the wavelengths of the energy under consideration so that each detector can be considered to operate on a point in space. If the radiated energy is electromagnetic then the detectors will be radiation detectors of some suitable type, able to produce a signal suitable for processing at each moment proportional to the intensity of the electromagnetic energy incident on it. If the wave energy is acoustic then the detectors will be microphones or pressure transducers of some appropriate sort. If the energy is conveyed in a wave on the surface of a liquid then the detectors will be height, velocity or acceleration measurers of an appropriate type. Other forms of radiated wave energy are dealt with in similar ways as appropriate.

The detectors are arranged in an array whose positions are fixed and accurately known in relation to each other. The signals from them will normally be electrical but they may be conveyed in some other suitable form. These signals are fed into a processor where the necessary computing operations as described above needed to calculate the frequency, phase and magnitude of each wave present can be carried out in real time.

The ‘pure moment’ for each wave can then be found and its true direction measured. According to the needs of the application those waves that are chosen are forwarded or reproduced or their characteristics are signalled in some suitable manner.

What is claimed is:

1. A device comprising a number of wave intensity detectors connected to a processing unit to distinguish the true direction of radiated wave energy, in an environment which contains surfaces capable of generating reflections and resonances, by measuring the direction of the wave on its first arrival before the first echo or a resonance can arrive.

2. A device substantially as described in claim 1 adapted to detect and measure sound energy.

3. A device substantially as described in claim 1 adapted to detect and measure electromagnetic energy.

4. A device substantially as described in claim 1 adapted to detect and measure surface waves on a liquid.

5. A device substantially as described in claim 1, which has more than two detectors and which finds the ‘pure moment’ by comparing the directions of the sound given by analysing the signals in two or more of the combinations of individual detectors to find when the difference between the different measurements of direction is least

6. A device substantially as described in claim 5 adapted to detect and measure sound energy.

7. A device substantially as described in claim 5 adapted to detect and measure electromagnetic energy.

8. A device substantially as described in claim 5 adapted to detect and measure surface waves on a liquid.
